(19) United States
(12) Patent Application Publication
(10) Pub. No.: US 2009/0311145 A1
(43) Pub. Date: Dec. 17, 2009

(54) REACTION CHAMBER STRUCTURAL PARTS WITH THERMAL SPRAY CERAMIC COATING AND METHOD FOR FORMING THE CERAMIC COATING THEREOF

(75) Inventors: Bo-Chen Wu, Hu Kou Hsiang (TW); Tsung-Chih Chou, Hu Kou Hsiang (TW); Jen-Yung Teng, Hu Kou Hsiang (TW); Shyue-Jer Chern, Hu Kou Hsiang (TW)

Correspondence Address: SCHMEISER, OLSEN & WATTS, 22 CENTURY HILL DRIVE, SUITE 302, LATHAM, NY, 12110, US

(73) Assignee: SHIH HER TECHNOLOGIES INC., Hu Kou Hsiang (TW)

(21) Appl. No.: 12/437,579

(22) Filed: May 8, 2009

(30) Foreign Application Priority Data
Jun. 17, 2008 (TW) 97122604

(51) Int. Cl. B01J 19/00; B05D 1/32

(52) U.S. Cl. 422/129; 427/448

(57) ABSTRACT

In a reaction chamber for manufacturing semiconductor devices, flat displays, solar panels, a thermal spray ceramic coating with special geometric patterns is provided on structural parts in the reaction chamber. The geometric patterns of the ceramic coating are designed according to operating conditions in the reaction chamber, such as the energy source and the plasma producing gases being used, the intended plasma distribution and subsequent reactions in the reaction chamber, and compositions of the ceramic coating. To form the ceramic coating with special geometric patterns, a special masking process is adopted, and, after the forming of the ceramic coating with desired geometric patterns, a post grit blasting treatment is conducted to obtain a desired surface coarseness for the ceramic coating.

### FIELD OF THE INVENTION

The present invention relates to a reaction chamber for manufacturing semiconductors, flat displays, and solar energy cells, and more particularly to reaction chamber structural parts with a ceramic coating; and the present invention also relates to a method for forming the ceramic coating on these structural parts.

### BACKGROUND OF THE INVENTION

FIG. 1 is a sectional view showing the structure of a typical pre-cleaning reaction chamber. As shown, the pre-cleaning reaction chamber is internally provided with a dome 18 made of quartz for covering a plasma bombardment space 14. When a radio frequency (RF) source 13 is mounted on a top 11 of the reaction chamber to serve as an energy source, plasma 16 may be produced in the plasma bombardment space 14 through the reaction of plasma source gases 17 which are supplied into the reaction chamber. The plasma source gases 17 may include argon (Ar), helium (He), and hydrogen (H₂). As a result, a reaction target 15, such as a silicon wafer, is cleaned at its surfaces due to a conducted plasma bombardment thereon. However, the above-described conventional process has the following disadvantages:
1. The plasma produced within the plasma bombardment space 14 is not uniformly distributed, leading to unevenly distributed surface properties on the reaction target 15 being cleaned. As a result, structural parts of the reaction chamber are exposed to the plasma bombardment space 14, due to being bombarded by the unevenly distributed plasma, tend to shorten usable life and become damaged earlier in need of necessitate replacement thereof.
2. Since the surface coarseness of the structural parts exposed to the plasma bombardment space 14 is not accurately controllable, localized damages formed on the surfaces of the structural parts caused by the unevenly distributed plasma are worsened. In other words, the surface coarseness of the structural parts in the reaction chamber is not well controlled from the very beginning of use of these structural parts, resulting in reduced free particle absorption ability, and accordingly, earlier damage and shorter service life of the structural parts.

### SUMMARY OF THE INVENTION

A primary object of the present invention is to provide a way of effectively minimizing the uneven distribution of plasma in a reaction chamber and effectively extending the usable life of the structural parts of the reaction chamber. In other words, the primary object of the present invention is to effectively prolong the service life of the structural parts in a reaction chamber, so that the cost for replacing the structural parts can be reduced while the working time of the entire equipment may be extended and enable increased productivity.

To achieve the above object, a solution is provided by the present invention to overcome the problems existed in the conventional reaction chamber, particularly a pre-cleaning reaction chamber, is to form a ceramic coating on both inner and outer surfaces of all the structural parts in the reaction chamber. With this ceramic coating, the structural parts in the reaction chamber exposed to the plasma bombardment are well protected against damages caused by the uneven distributed plasma in the reaction chamber, and therefore have extended usable life.

The present invention provides at least the following advantages:
1. The ceramic coating is formed on the inner and outer surfaces of the structural parts of the reaction chamber by thermal spray to form special geometric patterns, which may be varied according to different operating conditions in the reaction chamber for the RF energy source and the produced plasma to distribute in the reaction chamber uniformly, so that an even surface plasma bombardment effect may be produced on the target substrate (such as silicon wafer) to be cleaned and all the structural parts in the reaction chamber, allowing all the structural parts exposed to the plasma bombardment to maintain an extended service life.
2. Before the formation of the ceramic coating, a heat-resistant masking tape is applied on the structural parts to enable the forming of the ceramic coating with special geometric patterns. That is, a desired radio frequency (RF) pattern may be accurately formed and distributed under control for the ceramic coating with special geometric pattern to achieve the function of improving RF distribution.
3. A grit blasting process as a post treatment is conducted on all part surfaces with and without the ceramic coating to obtain a desired-uniform surface coarseness, which allows effective control of uniform distribution of free particles in the bombardment space to reduce the damages at localized areas on the reaction chamber structural parts. Therefore, structural parts in a pre-cleaning reaction chamber that are exposed to the plasma bombardment are protected by the ceramic coating without becoming aged earlier due to plasma bombardment concentrated at some specific areas thereof. Therefore, the structural parts may have prolonged service life without the necessity of being replaced frequently.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view showing the structure of a typical pre-cleaning reaction chamber;

FIGS. 2a to 2e show typical examples of geometric patterns of the ceramic coating for some of the structural parts of the reaction chamber of FIG. 1;

FIG. 3a to 3d show some structural parts of the reaction chamber of FIG. 1 are provided with the ceramic coating according to the present invention to achieve different surface properties; and

FIGS. 4a to 4e show some structural parts of the reaction chamber of FIG. 1, that have been provided with the ceramic coating with special geometric patterns according to a method of the present invention.

### DETAILED DESCRIPTION OF THE PREFERRED EMBODIMENTS

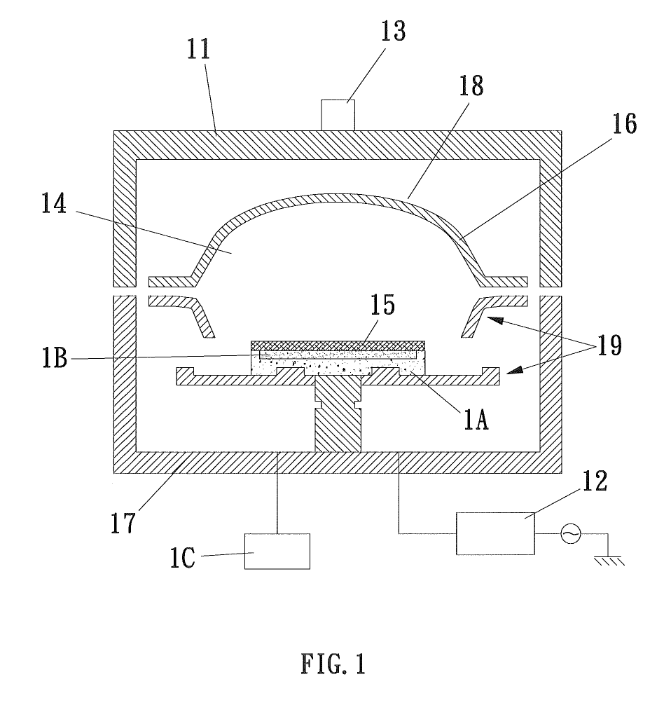

Please refer to FIG. 1 that is a sectional view showing the structure of a common and typical plasma bombardment cleaning reaction chamber used in the manufacturing process for semiconductor devices, flat displays, and solar panels. As shown, the reaction chamber is provided with an energy source 12. In the illustrated embodiment, the energy source is radio frequency. That is, the energy source herein is a radio frequency (RF) source 13 provided on the top 11 of the cleaning reaction chamber. In the reaction chamber, there is an internal space 14 defined among different structural parts of the reaction chamber for accommodating a substrate 15 to be treated in a reaction occurred in the reaction chamber. The substrate 15 may be of different materials, such as a silicon wafer. The internal space 14 may be maintained as an effectively closed vacuum environment, in which plasma 16 required for a cleaning process is produced. The substrate 15 to be cleaned is subjected to plasma bombardment cleaning in the internal space 14, so that surface contamination and cracks formed on the substrate 15 due to exposure to air and waiting during the manufacturing process may be removed from the substrate 15, ensuring the substrate 15 has required surface cleanness in subsequent reaction. The above-described process is referred to as plasma bombardment cleaning process.

In the plasma bombardment cleaning process, the environment for producing the plasma 16 is created by continuously ionizing and decomposing a reaction gas mixture 17 of Ar, He, H₂, etc. The RF source 13 provided on the top 11 of the reaction chamber provides the energy required for the ionization and decomposition of the reaction gas mixture 17. The energy provided by the RF source 13 on the top 11 of the reaction chamber is distributed in a whole lower portion of the reaction chamber. As a result, the target substrate 15 in the reaction is subjected to the plasma bombardment cleaning process to remove oxides and other contamination from its surfaces. In the cleaning process, the structural parts in the reaction chamber exposed to the plasma bombardment space 14, such as a dome 18, upper and lower protective baffles 19, a quartz-made insulator 1A, and an elevating platform 1B, are also subjected to the bombardment and accordingly, surface damages of different degrees, such as particle contamination, corrosion, cracks, or even surface peeling. These structural parts in the reaction chamber exposed to plasma bombardment may be well protected when their surfaces are provided with a thermal spray ceramic coating consisting of a ceramic material containing aluminum oxide (Al₂O₃), zirconia (ZrO₂), yttrium oxide (Y₂O₃), magnesium oxide (MgO) or calcium oxide (CaO), or any combination thereof. However, in the present invention, a thermal spray ceramic coating with special geometric patterns and desired coating surface properties, such as surface coarseness, hardness, and dielectric performance determined according to coating composition, is provided in a thermal spray process, so as to achieve some expecting advantages, including evenly distributed plasma 16 in the plasma bombardment space 14 in the reaction chamber. And, with the special ceramic coating patterns, the structural parts in the reaction chamber exposed to the plasma bombardment are well protected.

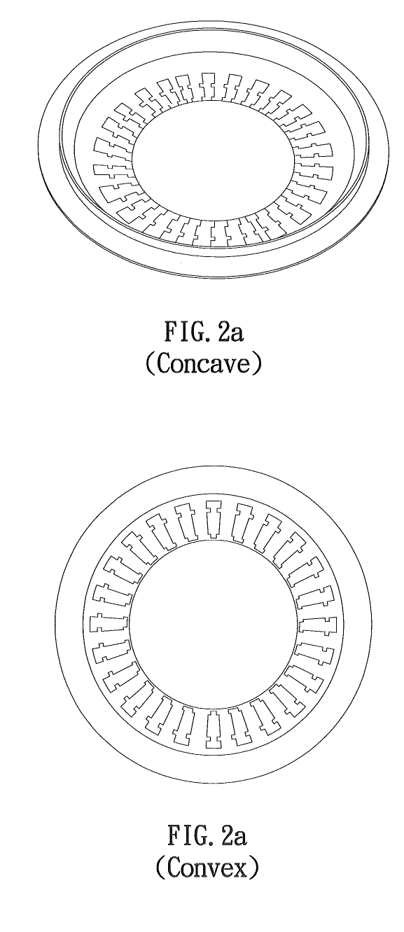

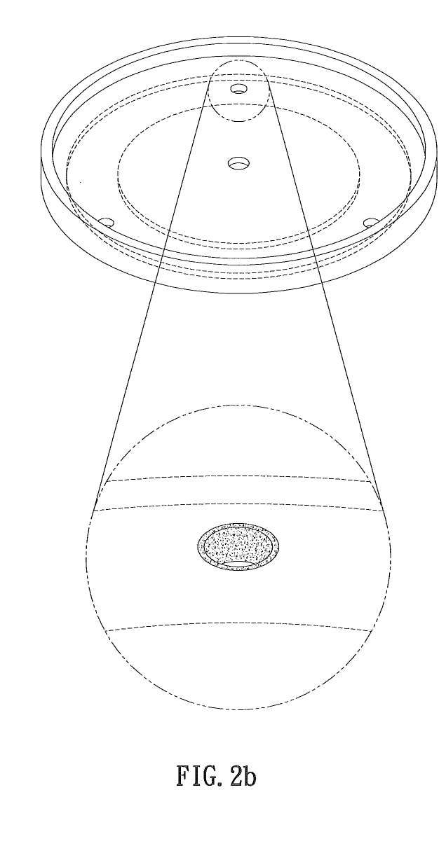

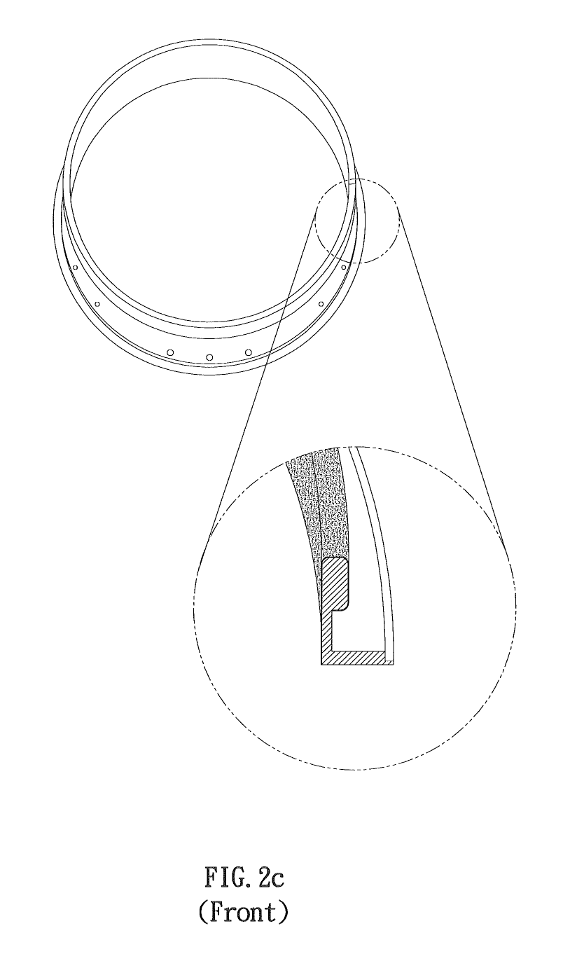

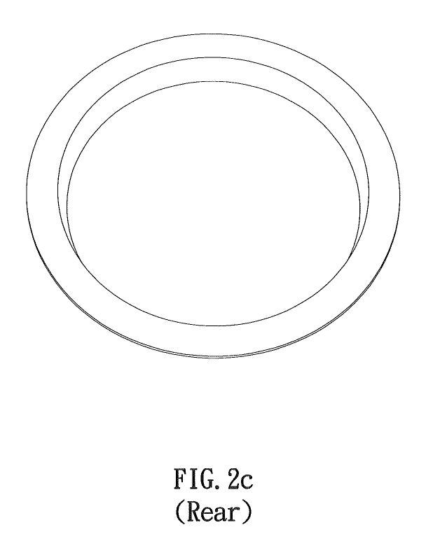

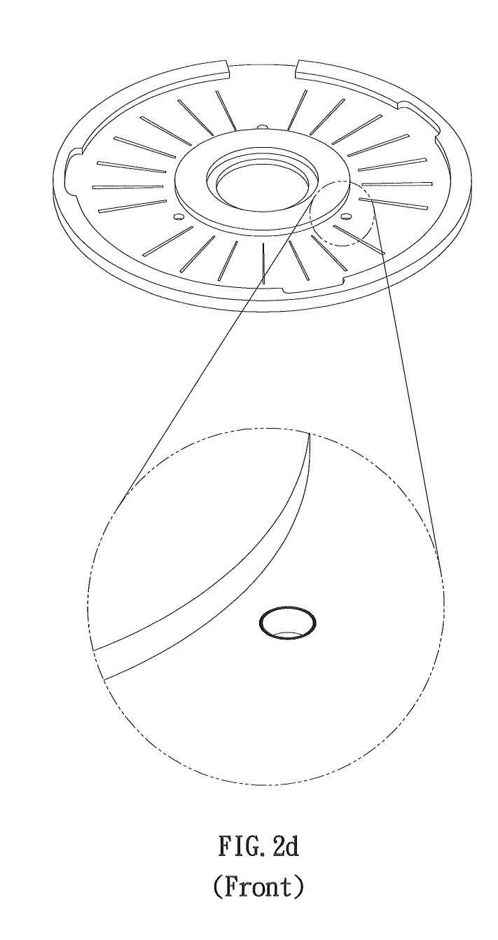

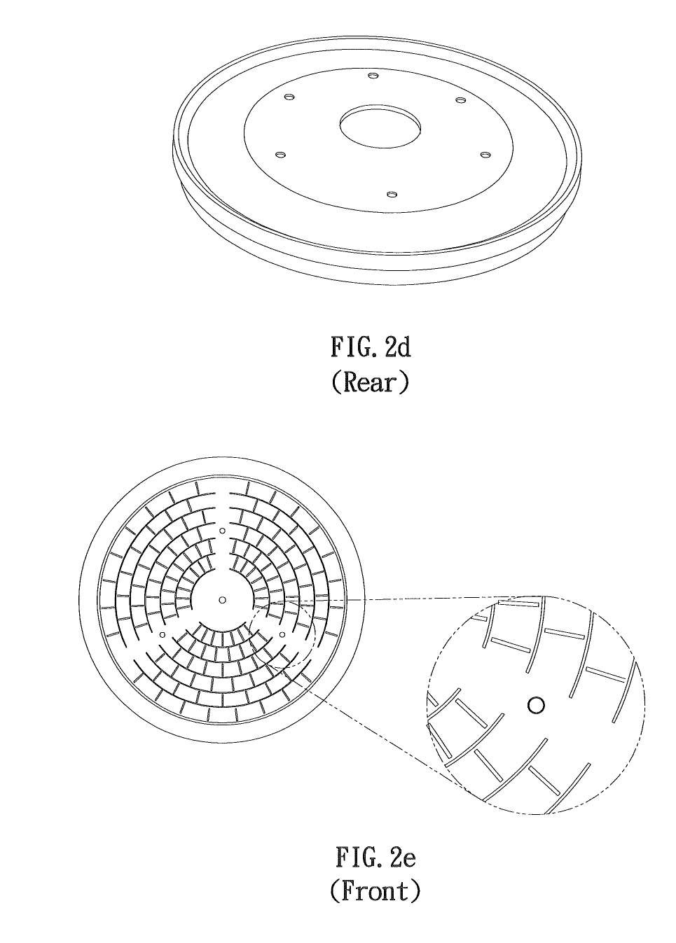

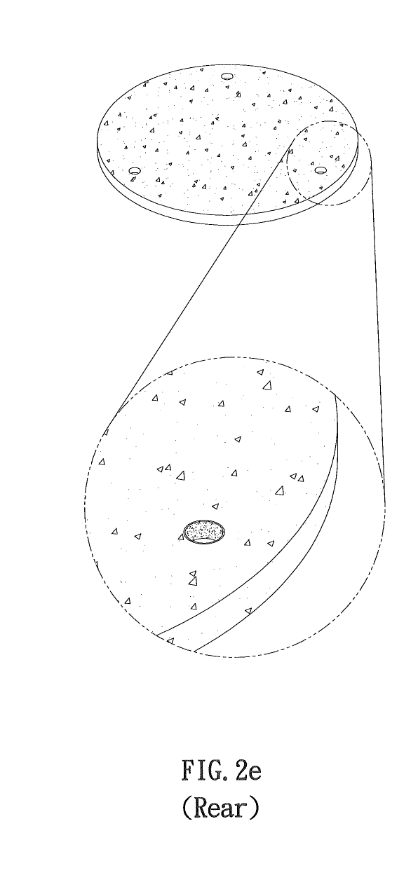

FIGS. 2a to 2e show some typical examples of geometric patterns for the ceramic coatings provided on the surfaces of the structural parts in the reaction chamber according to the present invention. However, it is understood the present invention is not limited to the illustrated patterns but may include more other usable patterns. More specifically, FIG. 2a shows upper and lower portion of the dome 18 with inner and outer surface containing one useful ceramic coating pattern, FIG. 2b shows the quartz-made insulator 1A with one useful ceramic coating pattern, FIG. 2c shows front and rear sides of the upper protective baffle 19 with one useful ceramic coating pattern, FIG. 2d shows front and rear sides of the lower protective baffle 19 with one useful ceramic coating pattern, and FIG. 2e shows front and rear sides of the elevating platform 1B with one useful ceramic coating pattern. With the present invention, the structural parts in the reaction chamber may be effectively protected against accelerated aging at some particular surface areas that are most frequently used in the pre-cleaning process and subsequent manufacturing process, and are therefore also protected against frequent replacement and shortened service life thereof.

In a method according to the present invention for forming the above-described ceramic coating with special geometric patterns on the structural parts in the reaction chamber, the formed ceramic coating has pre-designed patterns and the following physical properties for the structural parts to have effectively improved free particle capture ability:
1. A surface coarseness Rz ranging from 0.5 μm to 300 μm, depending on different structural parts and different operating conditions of the reaction chamber.
2. A surface hardness ranging from HV 150 to HV 1800, depending on a mean free path length of particles produced by different structural parts and the reaction substrate.
3. A dielectric value ranging between 10⁻² and 10³. The compositions of the ceramic coating are determined according to a desired dielectric property for the coated surface, and the dielectric value may be controlled according to the surface properties of the structural parts in the reaction chamber to be coated.

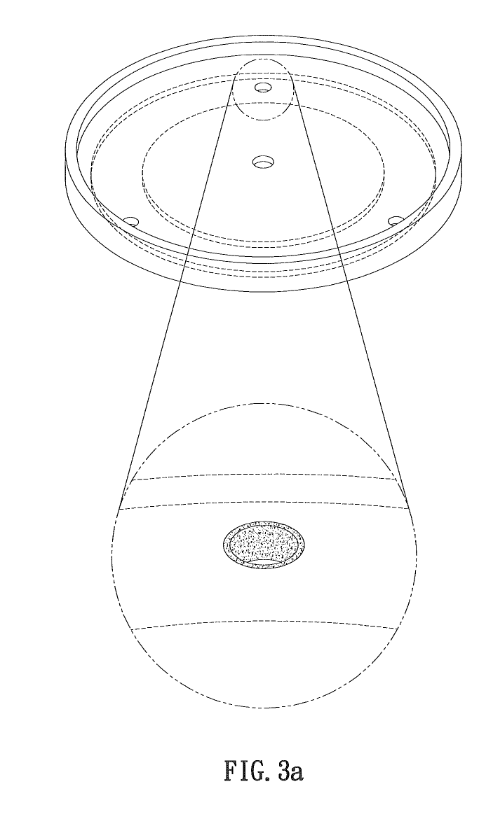

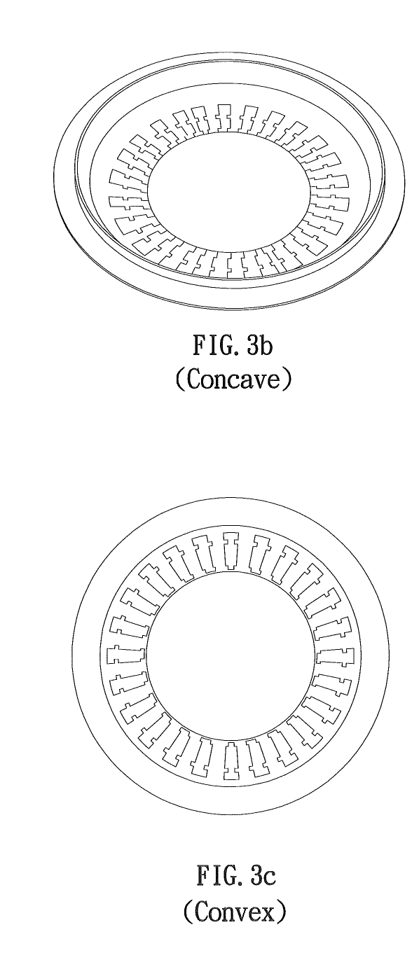

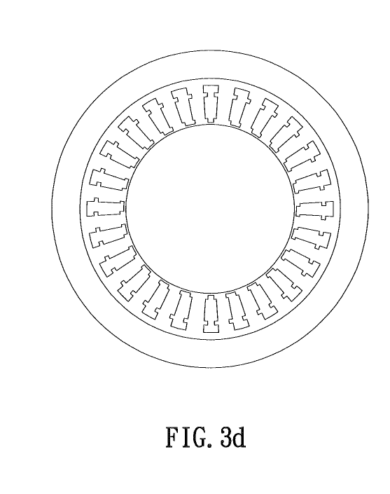

In FIG. 3a, there is shown a quartz-made insulator 1A being provided at an outer flange thereof with a high-dielectric coating to avoid arc discharge caused by conductive particle adsorption, which possibly occurs at the quartz-made insulator, the reaction substrate, such as a silicon wafer, and other areas. In other words, when the ceramic coating with special geometric patterns according to the present invention is applied to, for example, the inner and outer surfaces of a quartz-made dome 18 shown in FIGS. 3b and 3c, respectively, it is able to effectively create in the dome 18 an expected environment in which plasma 16 induced by RF source 13 is evenly distributed. Meanwhile, ion distribution condition in the plasma bombardment space 14 may be set through different operating parameters. The purpose of creating a uniform plasma distribution environment is not only to enable a uniform cleaning reaction on the surface of the reaction substrate, but also to avoid improperly shortened service life of the structural parts of the reaction chamber due to uneven plasma bombardment, and to effectively capture free ions in the reaction chamber to reduce irregular and localized surface damages on the structural parts.

An embodiment of the method of the present invention is implemented in a pre-cleaning system named Endura being used in a sputtering system as a pre-cleaning reaction apparatus thereof. The pre-cleaning system Endura is currently mass-produced by the Applied Materials, Inc. In the pre-cleaning system Endura, there is a plasma bombardment pre-cleaning reaction chamber for removing contamination and oxide film from the surface of a reaction substrate, such as the SiO₂ film formed on a bare wafer surface. The pre-cleaning system Endura has a structure as that shown in FIG. 1. The removed contamination and oxides are stirred and cumulated in a plasma environment in the plasma bombardment pre-cleaning process. According to an initially design of Endura, structural parts in the plasma bombardment reaction chamber are grit-blasted on their surfaces to produce a desired relatively high surface coarseness for capturing free particles moving in the space defined by the reaction chamber, so as to extend the mean time between overhaul (MTBO) of the reaction chamber. With the extended MTBO of the reaction chamber, production lines in the sputtering system may have more time for production to enable reduced loss brought by overhauls while enable upgraded productivity.

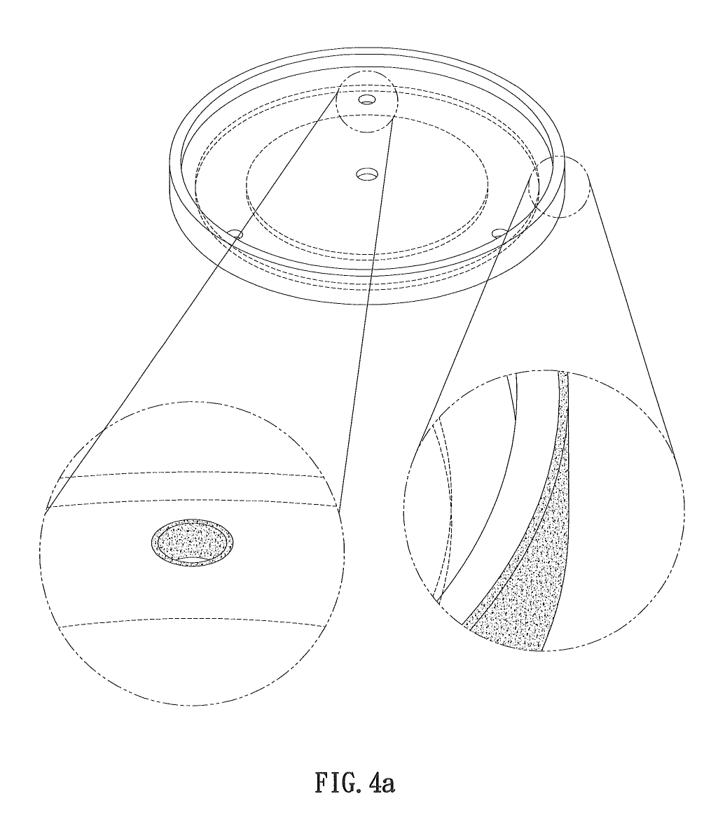

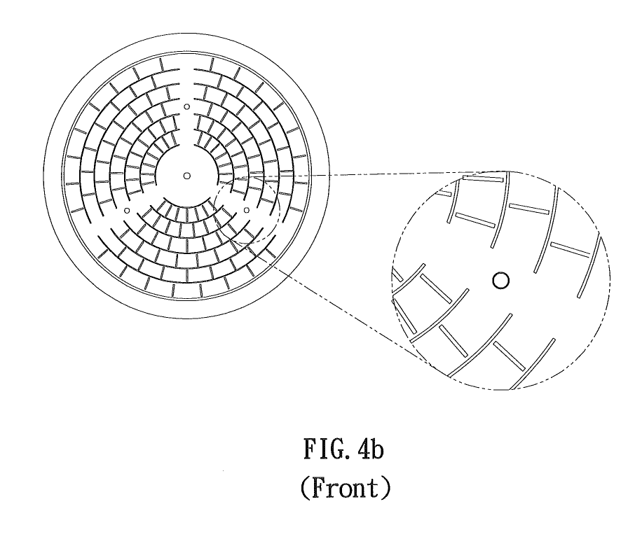

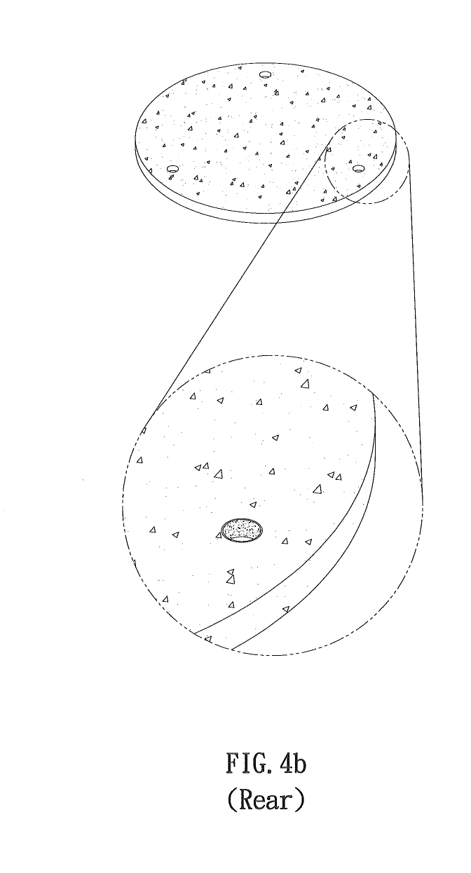

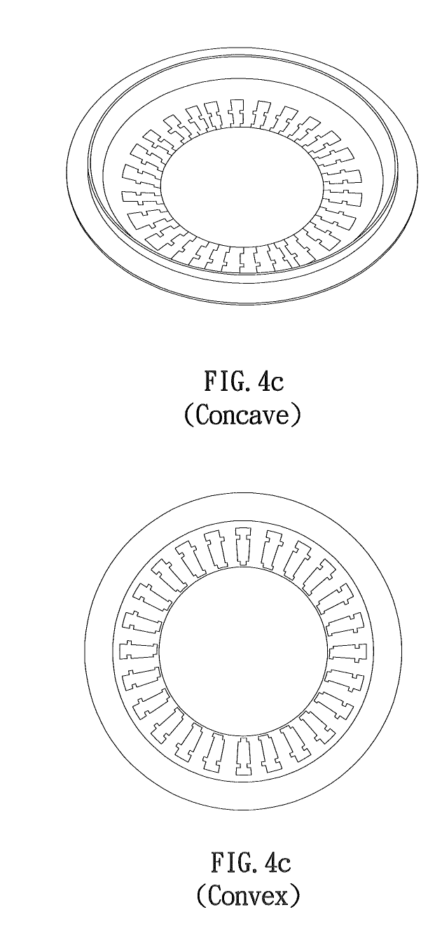

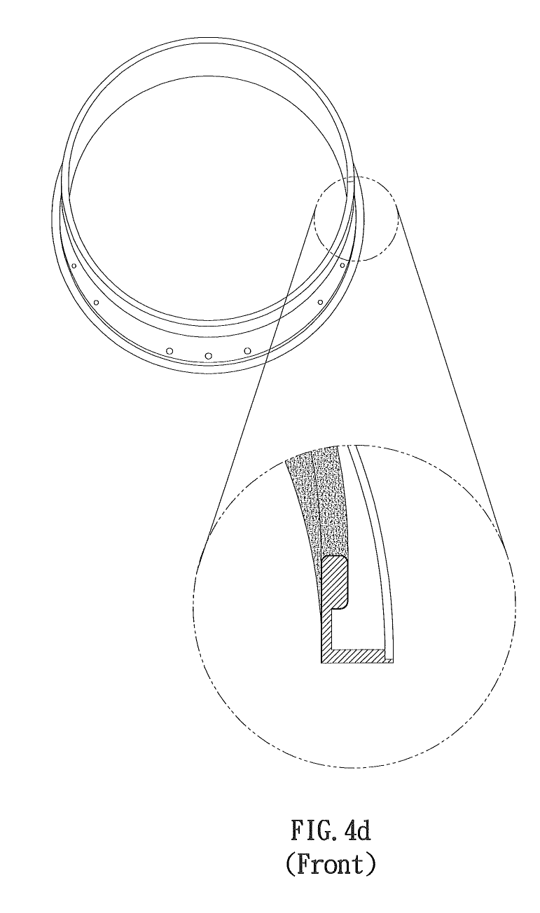

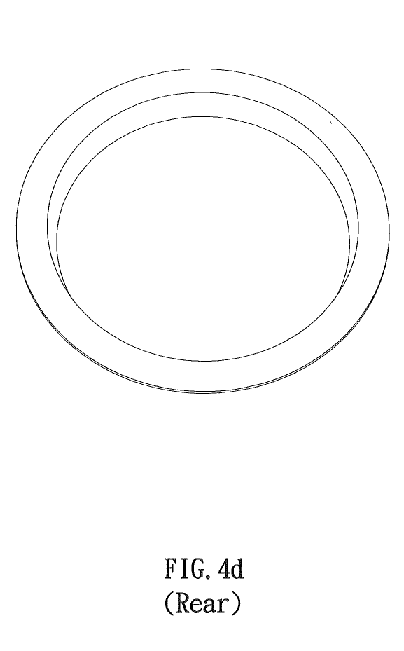

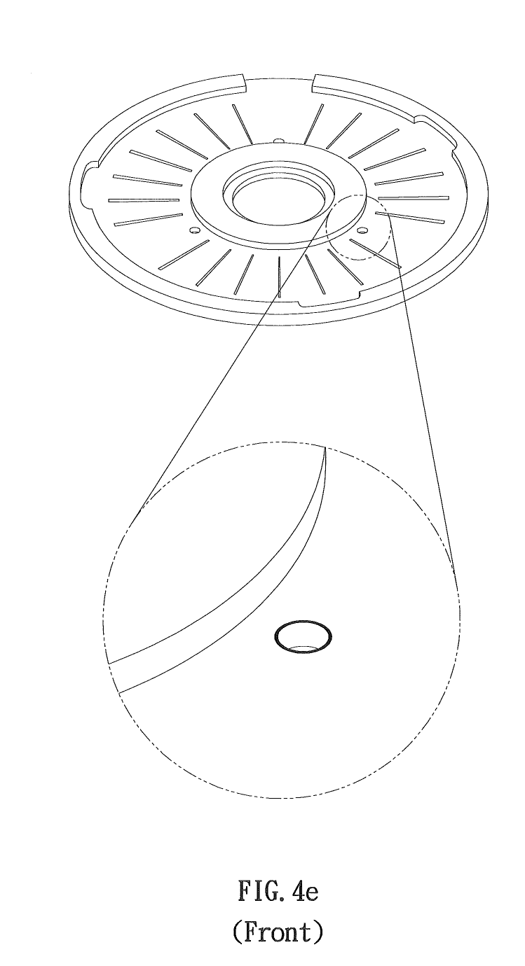

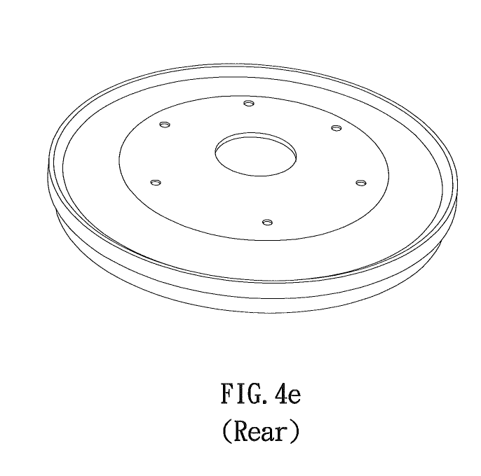

According to the method of the present invention, the ceramic coating provided on the structural parts in the plasma bombardment pre-cleaning reaction of Endura have a thickness ranging from 1 μm to 300 μm, and preferably, from 75 μm to 100 μm in the case of an aluminum oxide based ceramic coating; a surface coarseness Rz ranging from 0.5 μm to 300 μm, and preferably, from 20 μm to 40 μm; and a surface hardness ranging between HV 100 to HV 3000, and preferably, from HV 800 to HV 1000. And, the reaction chamber structural parts in the pre-cleaning system Endura having been provided with the ceramic coating with special geometric patterns according to the present invention include, for example, the quartz-made insulator 1A as shown in FIG. 4a, the elevating platform 1b as shown in FIG. 4b, inner and outer surfaces of the dome 18 as shown in FIG. 4c, front and rear surfaces of the upper protective baffle 19 shown in FIG. 4d, and front surface of the lower protective baffle 19 shown in FIG. 4e.

As experiments, the reaction chamber structural parts having the ceramic coating with special geometric patterns according to the present invention have been used on production lines for repeated operation, and it is found from the experiment results, the MTBO of the reaction chamber with the structural parts coated with the ceramic coating of the present invention is obviously extended and at least doubled; and the quantity of free particles caused by surface peeling or aging of the structural parts is reduced by at least 50%, compared to the structural parts without the specially patterned ceramic coating of the present invention. Also, it may be deduced the service life of these structural parts with the specially patterned ceramic coating of the present invention can be extended to be twice as long as the originally designed service life.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A reaction chamber comprising a plurality of internal structural parts, including from top to bottom a dome, an upper protective baffle, an elevating platform, a quartz-made insulator, and a lower protective baffle; and a substrate to be treated being rested atop the elevating platform; the reaction chamber being characterized in that all the internal structural parts thereof being provided on respective outer surfaces with a thermal spray ceramic coating, which shows specially designed geometric patterns, has specific surface coarseness, and includes a predetermined composition; and that the surface coarseness and other surface properties of the thermal spray ceramic coating may be further changed through post treatment.

2. The reaction chamber as claimed in claim 1, wherein the thermal spray ceramic coating has a surface coarseness ranging from 0.5 μm to 300 μm.

3. The reaction chamber as claimed in claim 1, wherein the thermal spray ceramic coating has a thickness ranging from 15 μm to 300 μm.

4. The reaction chamber as claimed in claim 1, wherein the thermal spray ceramic coating has a hardness ranging from HV 100 to HV 3000.

5. The reaction chamber as claimed in claim 1, wherein the thermal spray ceramic coating includes a ceramic material containing any one of aluminum oxide (Al₂O₃), zirconia (ZrO₂), yttrium oxide (Y₂O₃), magnesium oxide (MgO), calcium oxide (CaO), and any combination thereof.

6. The reaction chamber as claimed in claim 1, wherein the reaction chamber is usable in pre-cleaning semiconductor wafers, substrates for flat displays, and substrates for solar panels.

7. The reaction chamber as claimed in claim 1, wherein the post treatment includes post grit blasting treatment for controlling the surface coarseness of the thermal spray ceramic coating with special geometric patterns.

8. A method for forming a ceramic coating on structural parts in a reaction chamber, comprising the steps of:
forming on every outer surface of the structural parts of the reaction chamber a ceramic coatings with specific geometrical patterns, surface coarseness, and composition through a heat-resistant marking process; and
conducting a post treatment on the ceramic coating to change the surface coarseness and other surface properties of the ceramic coating.

9. The method as claimed in claim 8, wherein, in the heat-resistant masking process, a photoresist mask is used to protect areas on the outer surfaces of the structural parts that are not to be coated with the ceramic coating, and then, a thermal spray process is conducted to form the ceramic coating.

10. The method as claimed in claim 8, wherein, in the post treatment, differently sized glass beads are used to conduct grit blasting for controlling the surface coarseness of the ceramic coating.
